(19) United States
(12) Patent Application Publication
(10) Pub. No.: US 2026/0276048 A1
(43) Pub. Date: Sep. 17, 2026

(54) Damping Element With Variable Properties

(71) Applicant: HIRSCHMANN AUTOMOTIVE GMBH, Rankweil/Brederis (AT)

(72) Inventors: Thomas BREUSS, Rankweil (AT); Theo FETZ, Lustenau (AT)

(21) Appl. No.: 18/873,913

(22) PCT Filed: Jul. 25, 2023
(86) PCT No.: PCT/EP2023/070566

§ 371 Date: Dec. 11, 2024

(30) Foreign Application Priority Data
Jul. 25, 2022 (DE) 10 2022 118 566.4

(51) Int. Cl. F16F 1/377; H01R 13/58

(52) U.S. Cl. CPC F16F 1/377; H01R 13/58; F16F 2230/36; F16F 2234/02

(57) ABSTRACT

The invention relates to a damping element consisting of just one component. The damping element is arranged on an outer sheathing of a cable inside of which there is arranged at least one electrical conductor. The electrical conductor is preferably connected to a contact partner of a plug connector. The damping element has, in its wall, at least one recess preferably running parallel to the longitudinal axis of the damping element. By way of the at least one recess, the damping element is ensured that the compression forces are not too high when the tolerances are maximal, yet the damping element is nevertheless compressed when the tolerances are minimal.

The invention relates to a damping element, wherein the damping element is arranged on an outer sheathing of a cable, inside which there is arranged at least one electrical conductor, which is preferably connected to a contact partner of a plug connector.

### PRIOR ART

In the existing solution according to FIGS. 7 and 8, a sealing cap is pushed onto the line. The line (cable) comprises at least one electrical conductor 1, which is arranged inside an outer sheathing 2. At the end of each electrical conductor 1 there is arranged a contact partner 3. This arrangement according to FIG. 7 is, for example, part of a plug connector of a plug connection. The sealing cap is a part consisting of two components: a soft component made of silicone 4 and a hard component made of plastics material 5. The soft component is arranged coaxially within the hard component, and this structural unit consisting of two components is pushed over the outer sheathing 2. This part is also used for a plurality of line cross sections, but the material consumption (silicone) is correspondingly higher for small cross sections.

The invention is based on the object of improving the above arrangement, in particular by preventing/minimizing vibrations from contact in the installed/plugged state and by reducing material consumption.

This object is achieved by the features of claim 1.

According to the invention, it is provided that a damping element is used, consisting of just one component, wherein the damping element is arranged on an outer sheathing of a cable, inside which there is arranged at least one electrical conductor, which is preferably connected to a contact partner of a plug connector, wherein the damping element has, in its wall, at least one recess preferably running parallel to the longitudinal axis of the damping element, so that, by way of the at least one recess, it is ensured that the compression forces are not too high when the tolerances are maximal, yet the damping element is nevertheless compressed when the tolerances are minimal. The advantage of using only one component is that the second component is eliminated, thereby reducing material consumption. This also reduces the variety of parts to be installed.

A damping element is used that consists of only one component. If the desired damping properties and/or installation forces cannot be achieved immediately, these parameters can be easily changed by adjusting the hole geometry (number and shape of the recesses). This means that no complex adjustments/changes need to be made to affected and adjacent components.

The perforation also ensures that the compression forces are not too high when the tolerances are maximal, but that the damping element is nevertheless compressed when the tolerances are minimal. When applied to multiple cable cross sections in the same housing (for example a plug connector), not only are the properties controlled, but a corresponding amount of material is also saved.

The damping element consists of only one component (only one material). This saves a process step (providing and processing two elements made of different materials) and material. In addition, the variety of parts is reduced and the installation effort is reduced.

According to one exemplary embodiment of the invention, the damping element has, in its wall, at least one recess preferably running parallel to the longitudinal axis of the damping element. The recess(es) in the wall is (are) arranged symmetrically or asymmetrically. They can be completely surrounded by the material of the wall (like a bubble) or, for example, be open in a partial region (see, for example, the elongated cylindrical recesses of the exemplary embodiment in the figures). The cross section is, for example, round, oval, oblong, square, rectangular or the like.

If the desired damping properties and/or assembly forces cannot be achieved immediately, these parameters can be easily changed by adjusting the geometry of the recess(es) (what is known as the hole geometry, i.e., number and shape). This means that no complex adjustments/changes need to be made to affected and adjacent components.

The damping element is arranged on an outer sheathing of a cable, inside which there is arranged at least one electrical conductor, which is preferably connected to a contact partner of a plug connector.

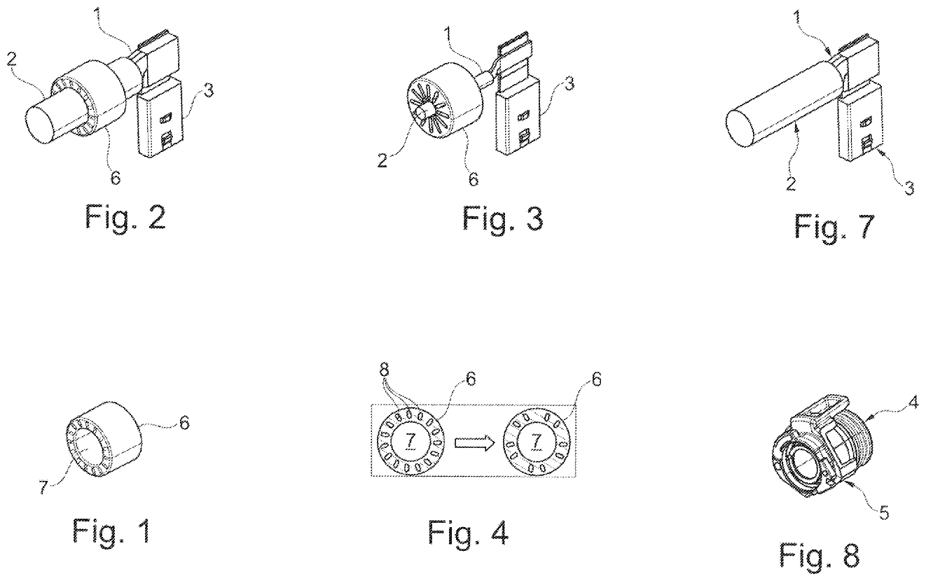

The damping element according to the invention is described and explained in more detail below with reference to FIG. 1 to 6

FIG. 1 shows the damping element 6 according to the invention, which has a wall around a through-opening 7 for the outer sheathing 2 of the cable. At least one recess (perforation), preferably a plurality of recesses, is arranged in the wall.

FIG. 2 shows that the damping element 6 has been pushed over the outer sheathing 2.

FIG. 3 also shows that the same damping element 6 as in FIG. 2 has been pushed over the outer sheathing 2. However, it can be seen here that the outer sheathing 2 according to FIG. 2 has a larger outer diameter than the diameter of the outer sheathing 2 according to FIG. 3. This also makes the decisive advantage of the damping element 6 according to the invention immediately apparent: by widening (elongated expansion) of the recesses in the damping element 6, it can be adapted to different diameters of the outer sheaths 2 of different cables via its through-opening 7.

This adaptation is variable and can be adjusted by the number and/or cross sections of the recesses. This is shown, for example, in FIG. 4. There, it can be seen that the damping element 6 (shown on the left in FIG. 4) has a significantly larger number of recesses 8 in its wall around the through-opening 7 than the damping element 6 shown on the right in FIG. 4. By changing the number of recesses 6 and/or their geometries, it is possible to change the range of the diameter of the through-opening 7 in precisely defined values, For example, the damping element 6 according to the left-hand illustration in FIG. 4 can be expanded considerably further (the diameter of the through-opening 7 can thus also be made considerably larger) than is possible with the damping element 6 according to the right-hand illustration in FIG. 4. This can optionally also be combined with different materials.

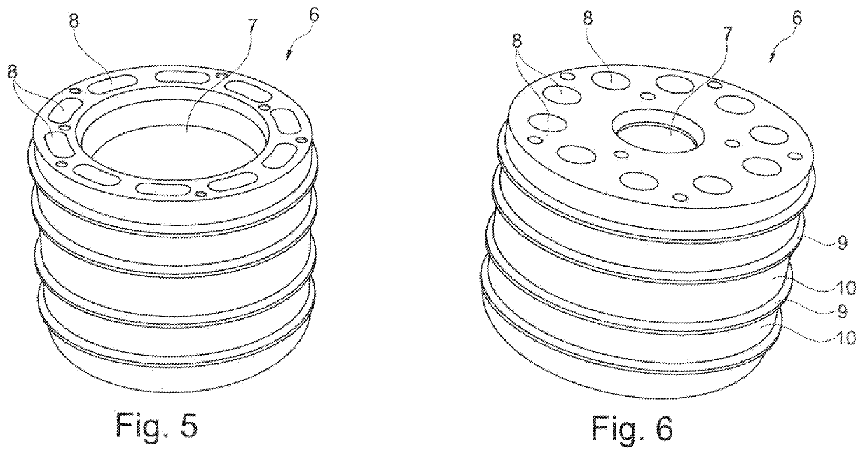

At this point it should be mentioned that the damping element 6, which is shown in FIG. 1 to 4, has recesses 8 that extend in an elongated radial manner in the wall of the damping element 6. Of course, it is conceivable to change the shape of the cross section as well as the position of a particular recess 8 in the wall of the damping element 6. For example, recesses 8 having a round cross section are also possible, as are recesses 8 that have a cross section that is elongated but oriented transversely to the radial extension (i.e., recesses 8 rotated by 90° with respect to the recesses 8 in FIG. 1 to 4). At this point it should be mentioned that this is shown in FIG. 5.

In order to secure the position of the damping element 6 on the outer sheathing 2, it is conceivable that elements are provided that protrude from the through-opening 7 in the direction of the central longitudinal axis of the damping element 6, such as at least one circumferential web (aligned transversely or parallel to the longitudinal axis of the damping element 6), one or more knobs or the like.

In addition or as an alternative, it is provided that the damping element 6 has at least one circumferential web 9 and/or at least one circumferential recess 10 on its circumferential surface. This is shown in FIGS. 5 and 6.

In a further embodiment of the invention, it can also be seen that the at least one circumferential web 9 is arranged set back relative to one end (front side) of the damping element 6.

In the two embodiments according to FIG. 5 and FIG. 6, it can be seen that the damping element 6 has, on its circumferential surface, four circumferential webs 9 having circumferential depressions 10 arranged between or next to them. Of course, it is also possible to provide fewer or more than four circumferential webs having the corresponding depressions 10. A web 9 is defined, for example, by the fact that it forms the largest outer diameter of the damping element 6. In contrast, the bottom of the depression 10 has a smaller, i.e., recessed, outer diameter of the damper element 6. If multiple webs 9 are present, they all have the same outer diameter, but can alternatively have different outer diameters. The same applies to the depressions 10, which can all have the same outer diameter or different outer diameters.

Looking at FIG. 5, it can still be seen that the recesses 7 in this damping element 6 are arranged transversely to the radial extension in the wall. Looking at FIG. 6, it can be seen that recesses 8 having a round cross section are provided in the wall of the damping element 6. In addition, the damping elements 6 shown in FIGS. 5 and 6 have through-openings 7 of different sizes so that they can be pushed onto the outer sheathing of cables having different diameter ranges. Explained using an example, this means that the through-opening 7 of the damping element 6 according to FIG. 5 has an inner diameter of 15 mm. By expansion, this damping element 6 can thus be pushed onto cables whose diameter of the outer sheathing 2 is in the range between (slightly more than) 15 mm and 20 mm. However, if cables are to be used whose diameter of the outer sheathing 2 is in the range between (slightly more than) 5 mm and 10 mm, the damping element 6 according to FIG. 6 is used, in which the inner diameter of the through-opening is 5 mm. The dimensions mentioned above (in mm: millimeters) are examples only and can easily be varied depending on the application.

In a special embodiment, the circumferential outer geometry of the damping element 6 shown in FIGS. 5 and 6 is also present on the inside in the region of the through-opening 7, wherein the number of webs/depressions between the inside and the outside can be the same or different.

To summarize once again, the invention thus relates to a damping element consisting of just one component (just one material), wherein the damping element is arranged on an outer sheathing of a cable, inside which there is arranged at least one electrical conductor, which is preferably connected to a contact partner of a plug connector, wherein the damping element preferably has, in its wall, at least one recess preferably running parallel to the longitudinal axis of the damping element, wherein the recess(es) accommodated in the wall are arranged symmetrically or asymmetrically and are completely surrounded by the material of the wall (in the manner of a bubble) or, for example, are also open in a partial region, so that the at least one recess (perforation) ensures that the compression forces are not too high when the tolerances are maximal, yet the damping element is nevertheless compressed when the tolerances are minimal.

### List of Reference Signs

1. electrical conductor
2. outer sheathing
3. contact partner
4. silicone
5. plastics material
6. damping element
7. through-hole
8. recess (perforation)
9. circumferential web
10. circumferential depression

1.-8. (canceled)

9. A damping element, consisting of just one component, wherein the damping element is arranged on an outer sheathing of a cable, inside which there is arranged at least one electrical conductor, which is preferably connected to a contact partner of a plug connector, wherein the damping element has, in its wall, at least one recess preferably running parallel to the longitudinal axis of the damping element, so that, by way of the at least one recess, the damping element is ensured that the compression forces are not too high when the tolerances are maximal, yet the damping element is nevertheless compressed when the tolerances are minimal.

10. The damping element according to claim 9, wherein the at least one recess(es) accommodated in the wall of the damping element is (are) arranged symmetrically in the wall.

11. The damping element according to claim 9, wherein the at least one recess(es) accommodated in the wall of the damping element is (are) arranged asymmetrically in the wall

12. The damping element according to claim 9, wherein the at least one recess(es) accommodated in the wall of the damping element is (are) completely surrounded by the material of the wall.

13. The damping element according to claim 9, wherein the at least one recess(es) accommodated in the wall of the damping element is (are) partially or completely open.

14. The damping element according to claim 9, wherein the damping element has at least one circumferential web and/or at least one circumferential depression on its circumferential surface.

15. The damping element according to claim 14, wherein the at least one circumferential web is arranged set back relative to one end of the damping element.

16. The damping element according to claim 14, wherein the damping element has, on its circumferential surface, four circumferential webs having circumferential depressions arranged between or next to them.
